(19) United States
(12) Patent Application Publication
(10) Pub. No.: US 2007/0202792 A1
(43) Pub. Date: Aug. 30, 2007

(54) Car power source apparatus

(76) Inventors: Hideo Shimizu, Kakogawa-city (JP); Tsuyoshi Komaki, Kasai-city (JP); Kazuhiro Fujii, Taka-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/702,073

(22) Filed: Feb. 5, 2007

(30) Foreign Application Priority Data
Feb. 28, 2006 (JP) 53888/2006

(51) Int. Cl. B60H 1/00

(52) U.S. Cl. 454/69

(57) ABSTRACT

The car power source apparatus is provided with a battery case housing a plurality of rechargeable batteries in a battery compartment, and air ducts to carry ventilating air to the battery case and cool the batteries. A plurality of air inlet and outlet openings are provided through panels between the battery compartment and the air ducts. Air inlet and outlet openings are opened in a direction different from the direction of airflow in the ducts. Further, the power source apparatus has a plurality of airflow channels of differing length established inside an air duct in the direction of airflow. This divides ventilating airflow in the air duct into a plurality of airflow channels.

### BACKGROUND OF THE INVENTION

1. Field of the Invention

This invention relates to a car power source apparatus that cools batteries housed in a battery case by flowing air through ventilation ducts.

2. Description of the Related Art

An electric vehicle such as an electric automobile or a hybrid car, which is powered by both an internal combustion engine and an electric motor, uses a power source apparatus as a source of electric power to supply to a driving motor (or motors). The power source apparatus has many connected individual battery cells housed in a battery case.

A power source apparatus used in this type of application should establish high output voltage to supply power to a high output motor. Consequently, many individual battery cells are connected in series and housed in a battery case. For example, a power source apparatus installed in a hybrid car currently on the market connects several hundred individual battery cells in series to produce an output voltage of several hundred volts. In such a power source apparatus, five or six individual battery cells are connected in series to form a battery module, and many battery modules are housed in a battery case.

A power source apparatus installed in an electric vehicle such as a hybrid car discharges at high currents to speed up the motor when the car accelerates rapidly. In addition, the power source apparatus is charged with high currents via regenerative braking when decelerating or traveling downhill. Consequently, battery temperature can become considerably high. Since use extends to the hot environment of summer months as well, battery temperature can increase even further. Therefore, it is important for a power source apparatus housing many batteries in a battery case to provide efficient and uniform cooling of each battery inside. Various problems arise if temperature differentials develop between the batteries being cooled. For example, a battery that gets hot can degrade and its actual charge capacity at full charge will decrease. If a battery with reduced charge capacity is connected in series and is charged and discharged with the same current as other batteries, it can easily be over-charged or over-discharged. This is because the capacity to which the degraded battery can be fully charged and the capacity that can be completely discharged become smaller. Battery characteristics degrade dramatically with over-charging and over-discharging. Consequently, a battery with reduced actual charge capacity degrades in an accelerated fashion. In particular, if the battery's temperature becomes high, degradation is further increased. As a result, uniform cooling that generates no temperature differentials over any of the batteries is important for a power source apparatus housing many batteries in a battery case.

FIG. 1 shows a prior-art power source apparatus that houses many batteries in the battery compartment of a battery case and uniformly cools those batteries by forced ventilation in the battery compartment. In the power source apparatus of this figure, air ducts 94 are provided above and below opposite surfaces of the battery compartment 93. In addition, the battery compartment 93 is divided into a plurality of enclosed chambers 99 by partition walls 98, and three levels of batteries 91 are housed in each enclosed chamber 99. In this power source apparatus, ventilating air flows into the battery compartment 93 from an inlet air duct 94A established above the battery compartment 93, passes through the enclosed chambers 99 of the battery compartment 93, and exits from an exhaust duct 94B below. A power source apparatus with this structure can uniformly distribute ventilating air in each enclosed chamber 99 to uniformly cool the batteries 91. However, this power source apparatus cannot uniformly distribute ventilating air flowing in the inlet air duct 94A to each enclosed chamber 99. A power source apparatus with this structure has its battery compartment partitioned into fourteen enclosed chambers, and ventilating air flows from an air duct into each enclosed chamber. However, while enclosed chambers ventilated by a large amount of air flow receive 10% of the total air flow, enclosed chambers ventilated by only a small amount of air flow receive only 5% of the total air flow. Consequently, there is a factor of two difference in the amount of air flow received by enclosed chambers, and ventilating air flow cannot be introduced uniformly into each enclosed chamber from the air duct.

To avoid this type of drawback, a power source apparatus has been developed with air ducts that change in width along the direction of air flow (refer to Japanese Patent Application Disclosure HEI 11-180168 (1999).

### SUMMARY OF THE INVENTION

In the power source apparatus of Japanese Patent Application Disclosure HEI 11-180168 (1999), air duct width changes to make the amount of ventilating air flow uniform from a region near the inlet to the most interior region. However, the flow of ventilating air cannot be uniformly distributed to cool the batteries simply by a configuration that reduces air duct width in the direction of ventilating airflow.

The present invention was developed with the object of further resolving this drawback. Thus, it is a primary object of the present invention to provide a power source apparatus that can distribute airflow, in the direction of the air duct, uniformly to the battery compartment.

The car power source apparatus of the present invention has the following structure to achieve the object above. The car power source apparatus is provided with a battery case housing a plurality of rechargeable batteries in a battery compartment, and air ducts to carry ventilating air to the battery case and cool the batteries. A plurality of air inlet and outlet openings are provided through panels between the battery compartment and the air ducts. Inlet and outlet openings are opened in a direction different from the direction of airflow in the ducts. Air is passed through those openings to cool the batteries from an air duct into the battery compartment, or from the battery compartment to an air duct. In addition, the power source apparatus has a plurality of airflow channels of differing length established inside an air duct in the direction of airflow. This divides ventilating airflow in the air duct into a plurality of airflow channels. The power source apparatus above has the characteristic that airflow in an air duct can be uniformly distributed in the direction of airflow to ventilate the battery compartment and uniformly cool batteries housed in the battery compartment. This is because a plurality of airflow channels, having different lengths in the direction of flow, are established to partition the inside of the air duct, and ventilating air in the duct is divided into those airflow channels to allow uniform flow through a plurality of battery compartment inlet and outlet openings. In a power source apparatus with this configuration, the opening at the end of an airflow channel can be established next to a battery compartment inlet opening with reduced airflow to increase airflow to that inlet opening. For example, in the case where an inlet opening at the extreme interior of the air duct has a reduced quantity of airflow, the opening at the end of an airflow channel can be disposed at the extreme interior of the duct, and the quantity of airflow to that inlet opening can be increased.

In the car power source apparatus of the present invention, the inlet air duct, which supplies air to the battery compartment, can be divided into a plurality of airflow channels.

In the car power source apparatus of the present invention, the exhaust duct, which exhausts air from the battery compartment, can be divided into a plurality of airflow channels.

In the car power source apparatus of the present invention, a plurality of partition plates having different lengths are separated by set gap distances and disposed in a parallel fashion in the direction of flow inside an air duct. Thus, these partition plates can divide an air duct into a plurality of airflow channels.

Further, in the car power source apparatus of the present invention, a plurality of batteries can be housed in the battery compartment by arranging them along the direction of flow through the air ducts.

Still further, in the car power source apparatus of the present invention, the inlet air duct and exhaust duct are established at opposite surfaces (upper and lower in the figures) of the battery compartment, and an inlet panel and an outlet panel are provided between the battery compartment and the inlet air duct and exhaust duct respectively. Opposing sidewalls are established between the inlet panel and outlet panel, and the battery compartment is divided into a plurality of enclosed chambers via these opposing sidewalls. Batteries can be stacked in multiple levels and housed in the enclosed chambers between opposing sidewalls. Finally, in the car power source apparatus of the present invention, inlet and outlet openings can be provided through the inlet panel and the outlet panel located at opposite ends (upper and lower in the figures) of an enclosed chamber. The above and further objects and features of the invention will more fully be apparent from the following detailed description with accompanying drawings.

### BRIEF DESCRIPTION OF THE DRAWINGS

FIG. 1 is a cross-section view with one part enlarged showing one example of a prior art car power source apparatus.

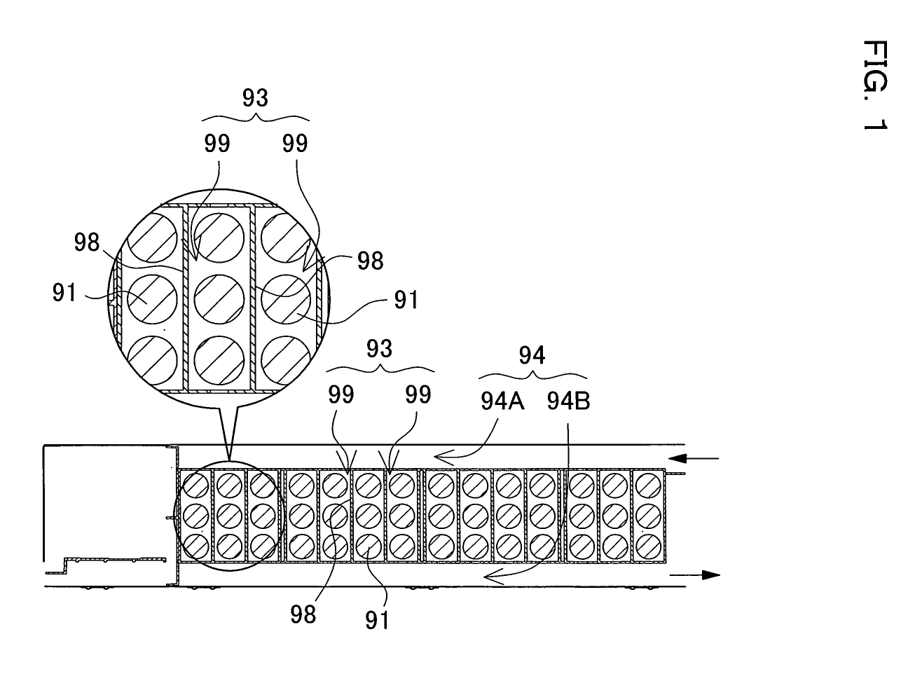

FIG. 2 is a cross-section view with one part enlarged of a car power source apparatus for an embodiment of the present invention.

FIG. 3 is an oblique view of the car power source apparatus shown in FIG. 2 with the top case removed.

FIG. 4 is a cross-section view with one part enlarged of a car power source apparatus for another embodiment of the present invention.

### DETAILED DESCRIPTION OF THE PREFERRED EMBODIMENTS

The following describes embodiments of the present invention referring to the drawings. However, the following embodiments are intended as examples of a car power source apparatus to make tangible the underlying technological ideas of the invention, and the car power source apparatus of the present invention is in no way specified by the following.

Further, in this application, part numbers indicated in the embodiments are also noted in the claims (and summary of the invention) to make the claims easier to understand. However, parts of the invention indicated in the claims are in no way restricted to the parts described in the embodiments.

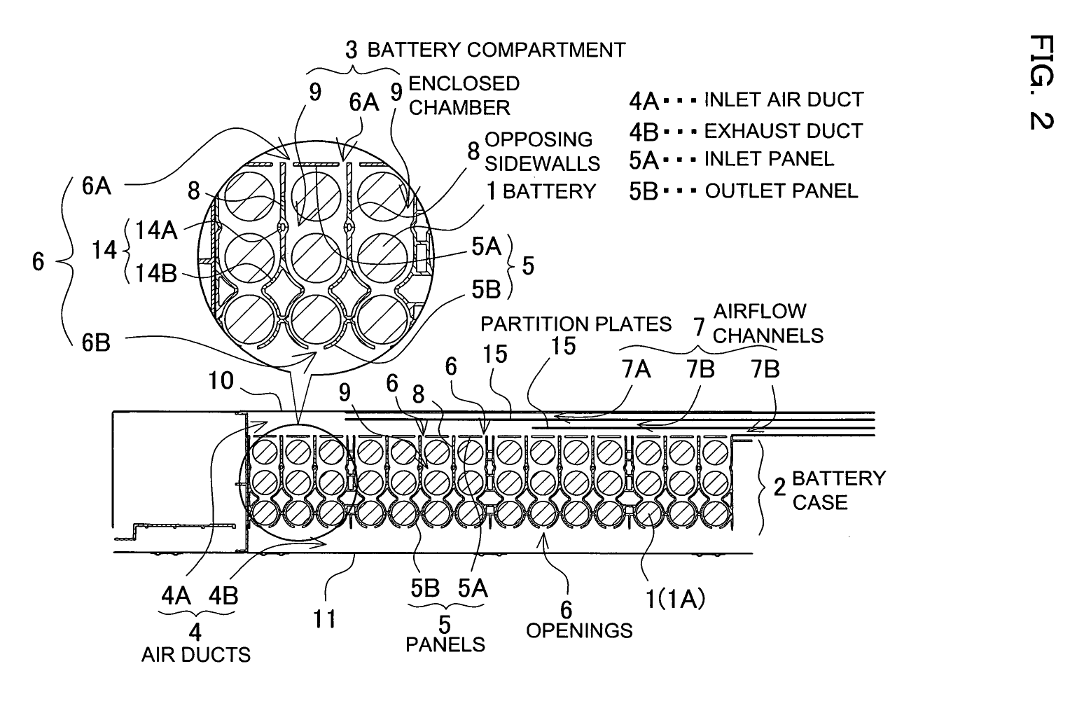

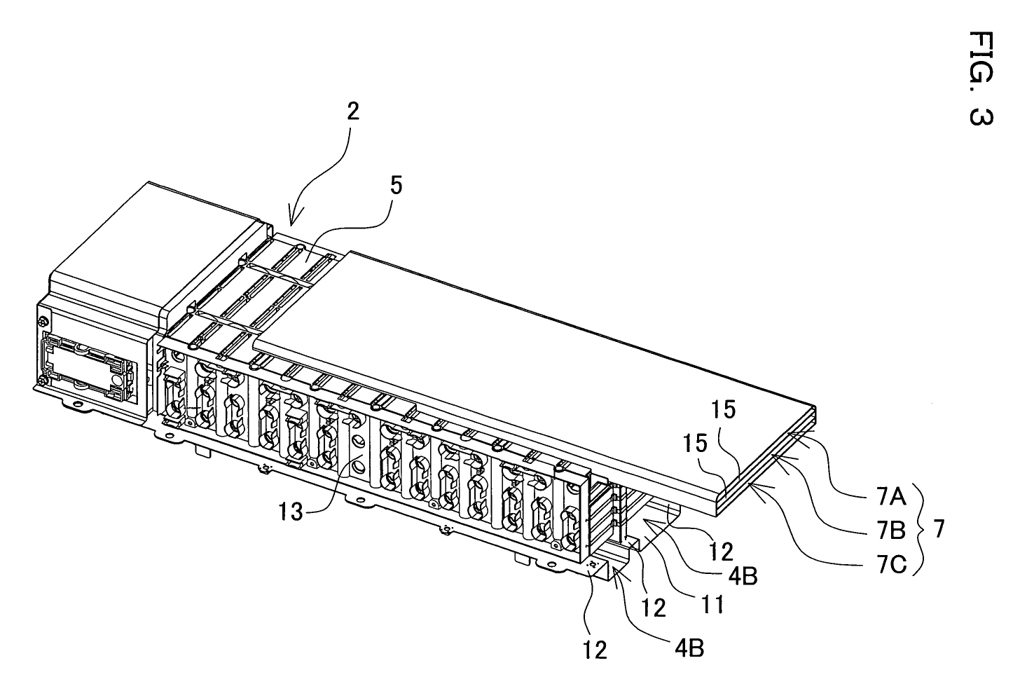

The power source apparatus shown in FIGS. 2 and 3 houses a plurality of batteries 1 in the battery compartment 3 of a battery case 2. Batteries 1 are housed in the battery case 2 as battery modules 1A. A battery module 1A is a series connection of a plurality of individual battery cells joined in a straight-line fashion. For example, a battery module 1A has five or six individual battery cells connected in a straight-line fashion. However, a battery module can also connect four or less, or seven or more individual battery cells. Individual battery cells are nickel hydrogen battery cells. However, individual battery cells can also be other rechargeable batteries such as lithium ion rechargeable batteries or nickel cadmium batteries. The battery modules 1A of the figures have circular cylindrical shapes and join circular cylindrical batteries in a straight-line fashion. In a power source apparatus housing battery modules 1A in a battery case 2, the number of battery modules 1A can be increased to raise the output voltage. However, the power source apparatus of the present invention can also be configured to house batteries other than battery modules, and specifically to house individual batteries.

Each of the plurality of battery modules 1A housed in the battery case 2 is connected in series via bus bars (not illustrated). However, battery case battery modules may also be connected in series and parallel.

The power supply apparatus of the figures is provided with an inlet air duct 4A outside the battery case 2 to supply air to the battery case 2 and an exhaust duct 4B to discharge air from inside the battery case 2. In this power supply apparatus, air flows from the inlet air duct 4A, through the battery case 2, to the exhaust duct 4B, and when the air passes through the interior of the battery case 2, it cools the battery modules 1A.

The power supply apparatus of FIG. 2 is provided with an inlet air duct 4A above the battery case 2 and an exhaust duct 4B below the battery case 2. The power supply apparatus can also be configured in an inverted disposition relative to that of FIG. 2. An inverted power supply apparatus cools battery modules inside the battery case by passing air upward from below. Air can flow smoothly through a battery case having an upward flow of air from below.

In the power source apparatus of FIGS. 2 and 3, a bottom case 11 is fixed to the bottom of the battery case 2, and a top case 10 is fixed to the top of the battery case 2 to establish air ducts 4 above and below the battery case 2.

The bottom case 11 shown in FIG. 3 is the frame for attaching the battery case 2. The bottom case 11 is provided with projections 12 along both sides and the center section. The battery case 2 mounts on those projections 12, and the exhaust duct 4B is established by the standoff between the battery case 2 and the bottom case 11. The vertical width of the exhaust duct 4B is adjusted by the height of the bottom case 11 projections 12. Although not illustrated, the height of the projections can be made gradually taller in the direction of flow to widen the vertical dimension of the exhaust duct in the direction of flow in a power source apparatus with the exhaust duct established between the battery case and bottom case.

The top case 10 is a cover over the upper surface of the battery case 2, and the inlet air duct 4A is established between the top case 10 and the battery case 2.

End-plates 13 located at both ends of battery modules 1A housed in the battery compartment 3 are fixed to the battery case 2. End-plates 13 are formed from an insulating material such as plastic, and hold bus-bars, which are attached to electrode terminals provided at both ends of each battery module 1A, in fixed positions. Bus-bars are metal plates that connect adjacent battery modules 1A in series. End-plates 13 screw-fasten with bus-bars to attach to battery modules 1A, and are held in fixed positions in the battery case 2.

The battery case 2 shown in FIGS. 2 and 3 houses battery modules 1A arranged horizontally in parallel fashion and stacked vertically in three levels. An inlet panel 5A is provided between the battery case 2 and the inlet air duct 4A, and an outlet panel 5B is provided between the battery case 2 and the exhaust duct 4B. Opposing sidewalls 8 are established between the inlet panel 5A and the outlet panel 5B, and the battery compartment 3 is divided into a plurality of enclosed chambers 9 via the opposing sidewalls 8. Batteries 1 are stacked in a plurality of levels and housed in the enclosed chambers 9. In the battery case 2 of the figures, three levels of battery modules 1A are housed inside a pair of opposing sidewalls 8, and the inlet and outlet sides of a pair of opposing sidewalls 8 are closed off by the inlet panel 5A and outlet panel 5B respectively. Specifically, an enclosed chamber 9, which is not an airtight enclosure, is formed by a pair of opposing sidewalls 8 and panels 5, and battery modules 1A are housed in three levels inside an enclosed chamber 9.

In the battery case 2 of the figures, inlet and outlet openings 6 are opened through the inlet panel 5A and the outlet panel 5B to ventilate battery modules 1A housed in the battery compartment 3 with cooling airflow. In the battery case 2 of the figures, inlet openings 6A are opened through the upper panel 5, which is the inlet panel 5A, and outlet openings 6B are opened through the lower panel 5, which is the outlet panel 5B. Air supplied to the power source apparatus flows from the inlet air duct 4A through inlet openings 6A provided in the inlet panel 5A into the enclosed chambers 9. Air that has cooled batteries 1 in the enclosed chambers 9 flows through outlet openings 6B provided in the outlet panel 5B and is discharged out the exhaust duct 4B.

Inlet openings 6A are opened on both sides of an enclosed chamber 9, and air introduced into an enclosed chamber 9 flows between the battery module 1A in the upper most level and opposing sidewalls 8. Inlet openings 6A are opened through the inlet panel 5A along (in FIG. 2, directly above) inner surfaces of opposing sidewalls 8. These inlet openings 6A introduce ventilating air that flows along the inner surfaces of opposing sidewalls 8 and passes between the upper most battery module 1A and the opposing sidewalls 8.

Although inlet openings 6A in the battery case 2 of the figures are opened on both sides of an enclosed chamber 9, they are not necessarily limited to positions directly over the inner surfaces of opposing sidewalls as shown in the figures. For example, inlet openings may be opened at locations somewhat towards the center of an enclosed chamber rather than directly over the inner surfaces of the opposing sidewalls. However, if an inlet opening is opened through the inlet panel at the center of an enclosed chamber, it may over-cool the upper most battery module relative to other battery modules. Although the amount of heat transfer is increased in cooling gaps where the upper most battery module 1A is in proximity with opposing sidewalls 8 on both sides, the amount of heat transfer is not increased in other regions. Cooling air flowing past the upper most battery module 1A has a lower temperature than cooling air flowing past other battery modules, and efficiently cools the upper most battery module 1A in the narrow cooling gaps.

If an inlet opening 6A were opened through the center of an enclosed chamber 9, air introduced into the battery case 2 from the inlet opening 6A would flow along the surface of the upper half of the upper most battery module 1A in the figures to cool that battery module 1A. Here, the upper most battery module 1A does not have its upper surface cooled by airflow, but rather is only cooled by cooling gaps formed on both sides where the upper most battery module 1A is in proximity with opposing sidewalls 8. This balances upper most battery module 1A cooling with other battery modules for uniform cooling. To realize this, the inlet openings 6A are not opened at the centers of enclosed chambers 9. Even if inlet openings 6A are adjusted from directly over inner surfaces of opposing sidewalls 8 towards the center, they are opened at locations outward of points between the center of an enclosed chamber 9 and directly above the inner surfaces of opposing sidewalls 8.

Outlet openings 6B are opened through the outlet panel 5B and positioned at the center of enclosed chambers 9. In the battery case 2 of the figures, air flowing out of an enclosed chamber 9 flows along the bottom part of the battery module 1A in the lower most level to efficiently cool the lower most battery module 1A. For an outlet opening 6B through the outlet panel 5B positioned at the center of an enclosed chamber 9, airflow divided on either side of the battery modules 1A flows along the lower half of the lower most battery module 1A, recombines at the center of the enclosed chamber 9, and is discharged through the outlet opening 6B.

In addition, the battery case 2 of the figures is provided with projections 14 on inner surfaces of opposing sidewalls 8 to control ventilating flow conditions in cooling gaps between each level of battery modules 1A and opposing sidewalls 8. Projections 14 are provided to extend into the crevices between vertically adjacent battery modules 1A. The height of the projections 14 protruding from an inner surface increases from upstream to downstream in the cooling airflow. The area that cooling gaps extend over downstream battery modules 1A, that is the contact area for cooling air with downstream battery modules 1A is greater than upstream. In addition, the width of downstream cooling gaps is narrower than upstream.

The amount of heat transfer afforded by cooling air flowing over a battery module 1A varies depending on the temperature difference between the air and the battery module 1A, the flow rate of the air, and the area of contact between the ventilating air and the battery module 1A. When there is little temperature difference between the air and the battery module 1A, the amount of heat transfer becomes small. Therefore, when the temperature of the air becomes high and the temperature difference relative to the battery module 1A becomes small, the amount of heat transfer becomes small. The temperature of the air rises downstream as battery module 1A heat is transferred to the air. Consequently, the amount of heat transfer from downstream battery modules 1A to the heated air decreases.

The amount of heat transfer can be increased by increasing the flow rate of the air and by increasing the contact area with the ventilating air. The height of the projections 14 sets the flow rate and contact area of the ventilating air with battery module 1A surfaces. If the height of the projections 14 is increased, they become closer to battery module 1A surfaces, and cooling gaps established between projections 14 and battery modules 1A become narrower. In addition, tall projections 14 also increase the contact area of cooling gaps established between projections 14 and battery modules 1A. Therefore, projections 14 compensate for reduced heat transfer due to gradual temperature increase in the ventilating air, and result in uniform cooling of all battery modules 1A.

In FIG. 2, battery case 2 opposing sidewalls 8 are provided with first projections 14A between the upper most battery module 1A and the mid-level battery module 1A, and with second projections 14B between the mid-level battery module 1A and the lower most battery module 1A. The second projections 14B are taller than the first projections 14A, and the second projections 14B are closer to the surfaces of the battery modules 1A than the first projections 14A.

Further, in the battery case 2 of the figures, surfaces of the second projections 14B on both sides are made as curved surfaces conforming to the surfaces of the opposing battery module 1A. These projections 14 establish cooling gaps between the projections 14 and battery modules 1A, and allow ventilating air to flow smoothly. In the battery case 2 of the figures, inside surfaces of the outlet panel 5B are also provided with curved surface regions that conform to the surfaces of opposing battery modules 1A. These outlet panel 5B curved surface regions, which are shaped to conform to battery module 1A bottom surfaces, serve a dual purpose as opposing sidewalls 8. However, the outlet panel of the battery case does not necessarily have to serve as opposing sidewalls, and the outlet panel can be planar while curved surface regions conforming to battery module surfaces can be provided on the inside surfaces of lower regions of opposing sidewalls. In this manner, a battery case 2 with curved surface regions can pass ventilating air along the surfaces of battery modules 1A, collect air at the outlet openings 6B, and discharge it to the outside. Consequently, the lower most battery module 1A can be efficiently cooled and decreased heat transfer due to air temperature rise can be compensated to reduce battery module 1A temperature differentials.

In a power source apparatus that houses three levels of battery modules in a battery case, it is not always necessary to provide first projections between upper most battery modules and mid-level battery modules. This is because cooling gaps can be established by the second projections to cool the downstream half of the mid-level battery module. Cooling gaps established by the second projections can provide more contact area with the ventilating air than upper most battery module cooling gaps, or they can be narrower than upper most battery module cooling gaps. Further, cooling gaps established by the second projections can provide less contact area with the ventilating air than lower most battery module cooling gaps, or they can be wider than lower most battery module cooling gaps. This allows the first battery module 1A, the second battery module 1A, and the third battery module 1A to be cooled uniformly.

In the battery case 2 described above, a plurality of openings 6 are opened through panels 5 between the battery compartment 3 and air ducts 4, and the openings 6 are disposed in a direction separate from the direction of airflow in the air ducts 4. Air is passed through these openings 6 from an air duct 4 into the battery compartment 3 and from the battery compartment 3 into an air duct 4 to cool batteries 1 in each enclosed chamber 9 of the battery compartment 3.

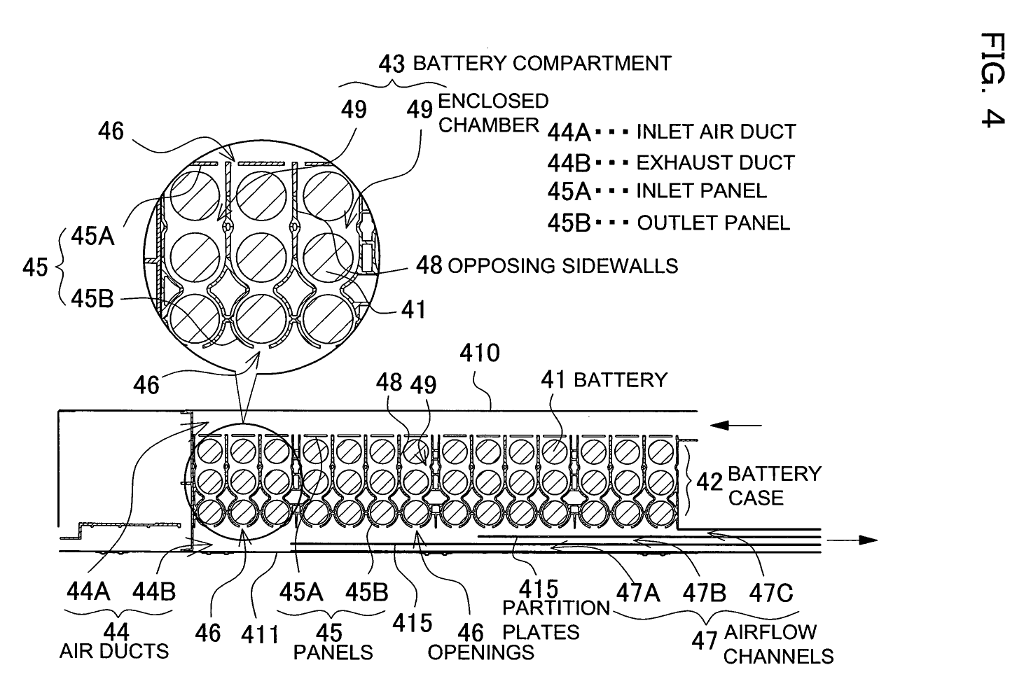

As shown in FIGS. 2 and 3, a plurality of airflow channels 7 of differing length are established inside an air duct 4 in the direction of airflow. This divides ventilating airflow in the air duct 4 into a plurality of airflow channels 7. In the power source apparatus of FIGS. 3 and 4, the inlet air duct 4A is divided into a plurality of airflow channels 7, but as shown in FIG. 4, the exhaust duct 44B can also be divided into a plurality of airflow channels 47. In the power source apparatus shown in FIG. 4, structural elements that are the same as the power source apparatus shown in FIG. 2 have the same part number except for the most significant (left-most) numeral, and their detailed description is abbreviated.

In the power source apparatus of FIGS. 2-4, a plurality of partition plates 15, 415 having different lengths are separated by set gap distances and disposed in a parallel fashion in the direction of flow inside an air duct 4, 44. Thus, these partition plates 15, 415 divide an air duct 4, 44 into a plurality of airflow channels 7, 47. In the air ducts 4, 44 of the figures, two partition plates 15, 415 having different lengths are provided to divide an air duct 4, 44 into three airflow channels 7, 47.

In the power source apparatus of FIG. 2, partition plates 15 are disposed in the direction of airflow from the intake opening of the inlet air duct 4A. In the power source apparatus of the figure, two partition plates 15 are disposed parallel to the panel 5. A first airflow channel 7A is established between a partition plate 15 and the top case 10, a second airflow channel 7B is established between the two partition plates 15, and a third airflow channel 7C is established between a partition plate 15 and the panel 5 to provide three levels of airflow channels 7.

Airflow channels 7 blow ventilating air into the inlet air duct 4A from openings at their ends inside the inlet air duct 4A. Positions of openings at the ends of airflow channels 7 can be changed by adjusting the lengths of the airflow channels 7. A long airflow channel 7 can position its end opening deep into the interior of the inlet air duct 4A, and a short airflow channel 7 can position its end opening only slightly down the inlet air duct 4A from its intake opening. The length of an airflow channel 7 can be adjusted to alter the position where air is discharged from the airflow channel 7 into the inlet air duct 4A. The power source apparatus of FIG. 2 is provided with three rows of airflow channels 7 having different lengths in the inlet air duct 4A.

The length of an airflow channel 7 is set by the position of the end of its partition plate 15. This is because the end of a partition plate 15 becomes the opening at the end of an airflow channel 7. In the power source apparatus of FIG. 2, the end of the upper partition plate 15 is positioned at the interior of the inlet air duct 4A, and more accurately is positioned at a region ¾ of the way down the entire air duct. Consequently, the first airflow channel 7A established by the upper most partition plate 15 has the opening at its end in a region ¾ of the way down the inlet air duct 4A, and this airflow channel 7A extends furthest into the inlet air duct 4A. The second airflow channel 7B, which is one level below the first airflow channel 7A, has the opening at its end positioned in the middle of the inlet air duct 4A. Therefore, the end of the second partition plate 15 from the top, which defines the opening at the end of the second airflow channel 7B, is positioned in the middle of the inlet air duct 4A. The lower most, third airflow channel 7C has the opening at its end positioned at the intake opening of the inlet air duct 4A.

In a power source apparatus provided with a plurality of airflow channels 7 in the inlet air duct 4A, the positions where airflow channels 7 discharge air into the inlet air duct 4A can be adjusted by altering the positions of the openings at the ends of the airflow channels 7. Openings at the ends of the airflow channels 7 are adjusted to uniformly supply air to each opening 6 and uniformly cool batteries 1 housed in each enclosed chamber 9.

In the power source apparatus of FIG. 4, partition plates 415 are disposed in a direction from the exhaust opening of the exhaust duct 44B towards its interior. In the power source apparatus of the figure, two partition plates 415 are disposed parallel to the panel 45. A first airflow channel 47A is established between a partition plate 415 and the bottom case 411, a second airflow channel 47B is established between the two partition plates 415, and a third airflow channel 47C is established between a partition plate 415 and the panel 45 to provide three levels of airflow channels 47.

Airflow channels 47 pull ventilating air from the exhaust duct 44B into openings at their ends inside the exhaust duct 44B. Positions of openings at the ends of airflow channels 47 can be changed by adjusting the lengths of the airflow channels 47. A long airflow channel 47 can position its end opening deep into the interior of the exhaust duct 44B, and a short airflow channel 47 can position its end opening only slightly down the exhaust duct 44B from its exhaust opening. The length of an airflow channel 47 can be adjusted to alter the position where air is sucked into the airflow channel 47 from the exhaust duct 44B. The power source apparatus of FIG. 4 is provided with three rows of airflow channels 47 having different lengths in the exhaust duct 44B.

The length of an airflow channel 47 is set by the position of the end of its partition plate 415. This is because the end of a partition plate 415 becomes the opening at the end of an airflow channel 47. In the power source apparatus of FIG. 4, the end of the lower partition plate 415 is positioned at the interior of the exhaust duct 44B, and more accurately is positioned at a region ¾ of the way down the entire air duct. Consequently, the first airflow channel 47A established by the lower most partition plate 415 has the opening at its end in a region ¾ of the way down the exhaust duct 44B, and this airflow channel 47A extends furthest into the exhaust duct 44B. The second airflow channel 47B, which is one level above the first airflow channel 47A, has the opening at its end positioned in the middle of the exhaust duct 44B. Therefore, the end of the second partition plate 415 from the bottom, which defines the opening at the end of the second airflow channel 47B, is positioned in the middle of the exhaust duct 44B. The upper most, third airflow channel 47C has the opening at its end positioned at the exhaust opening of the exhaust duct 44B.

In a power source apparatus provided with a plurality of airflow channels 47 in the exhaust duct 44B, the positions where airflow channels 47 suck air from the exhaust duct 44B can be adjusted by altering the positions of the openings at the ends of the airflow channels 47. Openings at the ends of the airflow channels 47 are adjusted to uniformly discharge air from each opening 46 and uniformly cool batteries 41 housed in each enclosed chamber 49. In FIG. 4, 42 is the battery case, 43 is the battery compartment, 44A is the inlet air duct, 45A is the inlet panel, 45B is the outlet panel, 49 are enclosed chambers, and 410 is the top case.

Further, the amount of ventilating air can be adjusted by the area of the opening at the end of an airflow channel 7, 47. The area of the opening at the end of an airflow channel 7, 47 can be increased by widening the gap distance between adjacent partition plates 15, 415. Consequently, the gap distance between partition plates 15, 415 can be widened to increase the area of the opening at the end of an airflow channel 7, 47 and increase the amount of ventilating air, and conversely the gap distance can be narrowed to decrease the area of the opening and decrease the amount of ventilating air.

Finally, the amount of ventilating airflow through an airflow channel can be adjusted by adjusting the internal drag or resistance to airflow inside the airflow channel. For example, the amount of airflow through an airflow channel can be reduced by inserting drag-producing material to increase resistance to airflow inside that airflow channel. Drag-producing material is material that passes air through that material but provides drag or resistance to the airflow. For example, drag-producing material can be an assembly of non-woven fibers, or open-cell plastic foam. The amount of airflow through a specific airflow channel is adjusted by inserting drag-producing material in that airflow channel. It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2006-053,888 filed in Japan on Feb. 28, 2006, the content of which is incorporated herein by reference.

What is claimed is:

1. A car power source apparatus comprising:
a battery case housing a plurality of rechargeable batteries in a battery compartment; and
air ducts to pass ventilating air through the battery case and cool the batteries,
wherein a plurality of openings are opened through panels between the air ducts and the battery compartment, ventilating air flows through those openings from an air duct to the battery compartment, and from the battery compartment to an air duct to cool the batteries, and
wherein a plurality of airflow channels of differing length are established inside an air duct in the direction of airflow, and this divides ventilating airflow in the air duct into a plurality of airflow channels.

2. A car power source apparatus as recited in claim 1 wherein the inlet air duct, which supplies ventilating air to the battery compartment, is divided into a plurality of airflow channels.

3. A car power source apparatus as recited in claim 1 wherein the exhaust duct, which accepts ventilating air discharged from the battery compartment, is divided into a plurality of airflow channels.

4. A car power source apparatus as recited in claim 1 wherein a plurality of partition plates having different lengths are separated by set gap distances and disposed in a parallel fashion in the direction of flow inside an air duct, and these partition plates divide the air duct into a plurality of airflow channels.

5. A car power source apparatus as recited in claim 4 wherein an inlet air duct is provided above the battery compartment; a plurality of partition plates having different lengths are separated by set gap distances and disposed in a parallel fashion in the direction of flow inside the inlet air duct; these partition plates divide the inlet air duct into a plurality of airflow channels; and the end of the upper most partition plate is positioned further to the interior of the inlet air duct than lower partition plates.

6. A car power source apparatus as recited in claim 4 wherein an exhaust duct is provided below the battery compartment; a plurality of partition plates having different lengths are separated by set gap distances and disposed in a parallel fashion in the direction of flow inside the exhaust duct; these partition plates divide the exhaust duct into a plurality of airflow channels; and the end of the lower most partition plate is positioned further to the interior of the exhaust duct than upper partition plates.

7. A car power source apparatus as recited in claim 1 wherein a plurality of batteries are housed in the battery compartment by arranging them along the direction of flow through the air ducts.

8. A car power source apparatus as recited in claim 1 wherein an inlet air duct and an exhaust duct are provided at opposite surfaces of the battery compartment; an inlet panel is provided between the battery compartment and the inlet air duct, and an outlet panel is provided between the battery compartment and the exhaust duct; opposing sidewalls are established between the inlet panel and the outlet panel; the battery compartment is divided into a plurality of enclosed chambers via the opposing sidewalls; and batteries are stacked in a plurality of levels and housed in the enclosed chambers between opposing sidewalls.

9. A car power source apparatus as recited in claim 8 wherein openings are provided through the inlet panel and the outlet panel positioned at opposite surfaces of the enclosed chambers.

10. A car power source apparatus as recited in claim 1 wherein the batteries are battery modules, which are a plurality of individual battery cells connected in series and joined in a straight line fashion, housed in the battery case.

11. A car power source apparatus as recited in claim 10 wherein the battery modules are five to six individual battery cells joined in a straight line fashion.

12. A car power source apparatus as recited in claim 10 wherein battery module individual battery cells are either nickel hydrogen batteries or lithium ion rechargeable batteries.

13. A car power source apparatus as recited in claim 10 wherein the battery modules are circular cylindrical batteries joined in a straight line fashion to form a longer circular cylindrical shape.

14. A car power source apparatus as recited in claim 1 wherein an inlet air duct is provided above the battery case, and an exhaust duct are provided below the battery case.

15. A car power source apparatus as recited in claim 1 wherein a bottom case is fixed to bottom of the battery case, a top case is fixed to the top of the battery case, and air ducts are established below and above the battery case.

16. A car power source apparatus as recited in claim 15 wherein a bottom case is a frame for mounting the battery case.

17. A car power source apparatus as recited in claim 16 wherein the bottom case is provided with projections along both sides and the center section, the battery case mounts on those projections, and the exhaust duct is established by the standoff between the battery case and the bottom case.

18. A car power source apparatus as recited in claim 15 wherein the top case is a cover that encloses the upper surface of the battery case, and the inlet air duct is established between the top case and the battery case.
